(19) United States
(12) Patent Application Publication
(10) Pub. No.: US 2024/0404160 A1
(43) Pub. Date: Dec. 5, 2024

(54) Method and System for Generating Digital Avatars

(71) Applicant: Apira Technologies, Inc., McLean, VA (US)

(72) Inventors: Michael Geertsen, Camano Island, WA (US); David Nett, Burbank, CA (US); Michael P. Gerlek, Bainbridge Island, WA (US); Yuri Alex Brigance, Mill Creek, WA (US); Kirk McKelvey, Bowdoinham, ME (US); Michael Kurtinitis, Stoughton, WI (US); Fred William Ware, JR., Oak Point, TX (US)

(73) Assignee: Apira Technologies, Inc., McLean, VA (US)

(21) Appl. No.: 18/680,092

(22) Filed: May 31, 2024

Related U.S. Application Data
(60) Provisional application No. 63/470,344, filed on Jun. 1, 2023.

(51) Int. Cl. G06T 13/40; G06T 7/73; G06T 17/20; G06V 40/16

(52) U.S. Cl. CPC G06T 13/40; G06T 7/73; G06T 17/20; G06V 40/171; G06T 2207/10028; G06T 2207/20081; G06T 2207/30201

(57) ABSTRACT

Embodiments of the invention are directed toward methods and computer graphics systems that can capture from a plurality of depth-sensing digital cameras, a series of images of an actor's face, and, in real time, without giving the actor special training and without using physical face markings, (1) extract from each of the captured images a set of facial landmarks of the actor's face; (2) transform those facial landmarks into a vector of expression blendshape coefficients that each correspond to a component expression identified in the actor's face; and then (3) output the vector of expression blendshape coefficients to a graphics rendering engine, where the vector can be applied to corresponding expression blendshapes associated with a digital avatar's face, thereby enabling the live actor's facial expressions to be transferred mathematically and rendered to the digital avatar's face in real time without revealing an image of the actor's face.

### CROSS-REFERENCE TO RELATED APPLICATIONS

This application claims priority under 35 U.S.C. § 119 (e) to U.S. Provisional Patent Application No. 63/470,344, entitled “Method and System for Generating Digital Human Avatars,” filed Jun. 1, 2023.

### FIELD OF THE INVENTION

Embodiments of the present invention relate generally to the technologies of virtual reality and augmented reality, including mixed reality, imaging, and visualization systems, and especially to systems and methods for animating virtual characters such as digital avatars. More specifically, embodiments of the present invention relate to computer graphics systems that are able to transfer the facial expression of a live actor onto a digital avatar in real time.

### BACKGROUND

Modern computing, graphics, and display technologies have facilitated the development of systems that are capable of generating virtual reality, augmented reality, and/or mixed reality experiences, wherein digital video images are presented to a user in a manner in which they may be perceived to be real. A virtual reality scenario typically involves presenting computer-generated virtual images. An augmented reality scenario typically involves presenting virtual images as augmentations of the actual world around a user. Mixed reality is a type of augmented reality in which physical and virtual objects may appear to co-exist and interact in the generated video imagery.

In the context of these various types of reality-display technologies, the general problem of transferring facial expressions from an actor's face to a virtual avatar's face has been a subject of much research and development.

On one end of the reality-display spectrum, people who make movies often make use of a process of motion capture, including facial motion capture. This is usually a time-intensive process requiring actor training, tracking physical dots placed on the actor's face and/or having the actor wear head-mounted camera gear. The process of generating video imagery with this technology is not performed in real time. Instead, images are rendered offline in very high resolution for cinematic use, which is not practical for a real time application such as video conferencing.

On the other end of the reality-display spectrum is a basic Snapchat filter and similar technology, where a cartoony or humorous modulation of an input image is made. This kind of image transformation is rendered in real time, but it is not life-like.

Deep-fake face swapping can be considered real time, and it also requires little or no actor training. However, the generated output suffers from unrealistic visual artifacts and struggles to portray expressions faithfully. It also has rendering issues with the inside of the mouth and can allow an actor's face to be shown accidentally if the face detection algorithm inadvertently latches onto something in the scene, other than the actor's face, which looks like a face.

Technologies such as 3D Movie Maker's face reconstruction method can produce a face mesh of an actor directly from an RGB image (without depth), thus allowing changes in the actor's face to drive changes in an avatar of the actor's own face, but this technology is not able to drive changes in an avatar of another person's face.

Systems and methods disclosed herein address the various challenges related to the above-described technologies.

### SUMMARY OF THE INVENTION

Embodiments of the present invention provide algorithmic methods and computer graphics systems that can, in combination and in real time, capture simultaneously, from one or more depth-sensing digital cameras, a series of images of an actor's face, and, in real time, without giving the actor special training and without using physical face markings, (1) extract from each of the captured images a set of facial landmarks of the actor's face; (2) transform those facial landmarks into a set of expression blendshape coefficients that together represent the overall expression of the actor's face as a vector; and then (3) output the vector of expression blendshape coefficients to a graphics rendering engine (such as the MetaHuman plugin for Unreal Engine), where the vector of expression blendshape coefficients can be applied to expression blendshapes associated with a digital representation of a different face (such as an avatar's face), thereby enabling the live actor's facial expression to be transferred mathematically—not visually—to the digital avatar's face in real time without revealing (or risking revealing) an image of the actor's face.

The above summary of embodiments of the present invention has been provided to introduce certain concepts that are further described below in the Description of the Embodiments. The summarized embodiments are not necessarily representative of the claimed subject matter, nor do they limit or fully span the scope of features described in more detail below. They simply serve as an introduction to the subject matter of the various inventions.

### BRIEF DESCRIPTION OF THE DRAWINGS

So that the manner in which the above recited summary features of the present invention can be understood in detail, a more particular description of the invention may be had by reference to embodiments, some of which are illustrated in the appended drawings. It is to be noted, however, that the appended drawings illustrate only typical or representative embodiments of the invention and are therefore not to be considered limiting of its scope, for the invention and this disclosure may admit to other equally effective embodiments.

FIG. 1 provides a simplistic overview illustration of an exemplary embodiment of the invention that extracts expressions from an actor's face and transfers mathematical representations of those expressions in real time to a rendering engine that can then render the mathematical representations of the expressions onto a digital avatar's face.

FIG. 2 illustrates an exemplary embodiment of a method and system for extracting mathematical representations of facial expressions from an actor's face in real time and transmitting coefficients of those mathematical representations to a rendering engine that can render the extracted representations of the actor's facial expressions onto an avatar's face.

FIG. 3 is a more detailed illustration of an exemplary embodiment of a method and system for transforming integrated 3-dimensional facial landmarks of an actor's face into coefficients of expression blendshapes that can be used by a rendering engine to render expressions obtained from an actor's face onto an avatar's face.

FIG. 4 illustrates an exemplary embodiment of a method for calibrating depth-sensing digital cameras for generating digital avatars, in accordance with the present invention.

FIG. 5 is a block diagram of an exemplary embodiment of a computing device 500, comprising a plurality of components, in accordance with the present invention.

### DEFINITIONS

The following definitions are provided for introductory illustration and educational purposes, to help one of ordinary skill in the art understand, make, and use the invention. The definitions are not intended to be limiting.

Actor: An actor is a human or other animated being, such as an animal or even a mechanical object or device, that is capable of generating facial expressions. The actor may be positioned in front of one or more cameras so that expressions on the actor's face can be captured and transferred to a rendering engine, where the actor's expressions may be portrayed on an avatar's face in real time.

Mesh: A mesh, or a polygon mesh, is a graph of edges and vertices, typically forming a set of 3- or 4-sided polygons that together represent the surface of a shape (such as a face or head) in 3-dimensional space.

Generic Mesh: A generic mesh is a mesh that represents a generic object such as a face—or a portion of a face—that does not look like anyone in particular but has an average shape and a set of average features.

Neutral Mesh: A neutral mesh is a mesh representing a specific object such as a face—or a portion of a specific face—with a blank or neutral expression.

Canonical Landmarks: Canonical landmarks are a set of well-defined canonical points in a static 3D model of a human face. Typically, embodiments use 468 canonical landmark points. However, other known landmark sets contain fewer landmarks, such as 68 or 39 landmarks.

With reference to the embodiments, there is a difference between “detected landmarks,” which can refer to a set of landmarks obtained by a Machine Learning model from an image of an actor's face, and “landmark vertices,” which refers to the set of face mesh vertices corresponding to the landmarks. Making the detected landmarks and the landmark vertices line up is key to “mesh fitting” (as defined below) and also key to the calculation of identity coefficients and expression coefficients. Furthermore, making single perspective detected landmarks, which have been obtained from two or more cameras, line up with each other is important to camera calibration.

Blendshape: A blendshape is a snapshot of a specific mesh in a given configuration or pose, analogous to a keyframe. When a mesh corresponds to a well-defined local region of an object—such as a corner of an eye on a human face, or a specific set of landmark vertices—an algorithm may then use a coefficient, which is a scalar multiplier normally in the range [0.0, 1.0], to blend or interpolate between a reference or neutral mesh of the same region and the corresponding blendshape. A coefficient of 0.0 implies 100% neutral mesh, a coefficient of 1.0 implies 100% keyframe or blendshape mesh, and any value in between represents a blend between the two.

A blendshape can be represented as a difference vector consisting of spatial adjustments to a specific set of vertices within a base mesh. Thus, an original base mesh, when modified by the blendshape, can yield a new shape.

Blendshape Coefficient: A blendshape coefficient is the coefficient identified in the definition of “blendshape” above. A blendshape coefficient describes a distortion of a blendshape or mesh.

Multiple blendshapes can be independently scaled by coefficients and combined additively.

A set of N blendshapes can be considered as a vector basis for an N-dimensional space spanning the possible range of output meshes. This is useful for understanding the process of mesh fitting, as described below.

Note that embodiments of the present invention utilize an expression space and an identity space. Each of these spaces involves the use of blendshapes and coefficients.

Expression Coefficient: An expression coefficient or expression blendshape coefficient is a scalar multiplier for any of the expression blendshapes that can morph a neutral mesh into a mesh that conveys a temporary distortion associated with an ephemeral expression.

Expression Vector: An expression vector is a set of coefficients for a set of expression blendshapes. An expression blendshape depicts an isolated facial movement, such as left side smile, right eyebrow raised, nostril flare, etc. An expression vector represents an overall facial expression (a set of expression blendshapes) at a moment in time.

Expression coefficients can have semantic value even outside of a given morphable face mesh. They can be applied to a morphable face mesh to produce an avatar directly, or a rendering system can use them to drive more sophisticated animation algorithms to render a topologically different face mesh.

Identity Coefficient: An identity coefficient or identity blendshape coefficient is a scalar multiplier for any of the identity blendshapes that can morph a generic mesh into a somewhat permanent neutral mesh corresponding to an individual person or actor or avatar displaying a blank expression.

A set of identity coefficients are probabilistically unique to each actor (because generally, no two people have the same face), and thus a set of identity coefficients do not change depending on what expressions an actor may make, and which a camera may then capture. Identity blendshapes are distilled from a principal component analysis (“PCA”) of a large sample of images, and therefore they generally do not have semantic value outside of a given morphable face mesh (i.e., there may be no intuitive correspondence between a given blendshape and what a human would think of as an identifying characteristic, such as “big nose”).

Identity Vector: Similar to an expression vector, an identity vector is a set of coefficients for a set of identity blendshapes.

Camera Intrinsic: A camera intrinsic is a numerical value that represents a measurement of a physical characteristic of a camera, such as its optical center or its focal length. Camera intrinsics are used to correct for lens distortion while de-projecting 3D coordinates from camera pixel/depth channels. The plural term, camera intrinsics, indicates a set of relevant camera intrinsic values.

Reference and Secondary Cameras: In a multi-camera system, the data from each camera's sensors will be produced in their own distinct coordinate spaces. One camera is (usually arbitrarily) chosen to the be the reference camera, and the data from the other secondary cameras are mapped into the coordinate space of the reference camera.

Landmark Mapping: A landmark mapping is a subset of the mesh vertices corresponding to the Canonical Landmarks.

Geometric Affine Transformation: A geometric affine transformation is a spatial geometric transform that preserves lines and parallelism. Within the embodiments, affine transformations are strictly used for rigid alignment and as such will additionally preserve linear ratios and angles, which means no shearing. Affine transforms or transformations are also used in the embodiments to perform coordinate system translations using scale, rotation and translation operations.

Face Orientation Matrix: A face orientation matrix is an affine transformation in matrix form, representing the size, orientation and position of an actor's head, corresponding to the scale, rotation and translation components of the transform.

Kabsch-Umeyama Point Registration Algorithm: A Kabsch-Umeyama Point Registration Algorithm (also “K-U algorithm”) is a method known to those skilled in the art to numerically compute (or estimate) an affine transformation between two sets of points.

Weighted Average of Vertices: A weighted average of vertices is a method known to those skilled in the art to represent a non-mesh point as a weighted average of the three closest mesh vertices.

Least Squares Approximation: A least squares approximation is a method known to those skilled in the art to fit observed data with a parameterized linear model by minimizing the sum of the squared residuals (distances of observed data points from the model). In embodiments of the present invention, the observed data is the set of 3D integrated landmarks; the linear model consists of the expression and identity blendshape vector bases (independently); and the parameters are the expression and identity coefficient values.

Morphable Face Mesh: A morphable face mesh consists of a base “generic” face mesh and a set of closely related blendshapes organized into two groups: (1) the expression blendshapes defining isolated expression movements of a face that, when combined, can span the full range of possible facial expressions; and (2) the identity blendshapes, usually statistically determined to define a range of possible head and face shapes.

The expression blendshape coefficients and the identity blendshape coefficients are represented as difference vectors (see above).

The set of (N) expression blendshapes can be treated as a vector basis for an N-dimensional space of possible facial expressions.

The set of (M) identity blendshapes can be treated as a vector basis for an M-dimensional space of possible face/head shapes.

The base mesh is generic (i.e., the head shape representing the statistical mean) and neutral (expressionless).

A neutral (expressionless) specific mesh (or partial mesh) may be computed by applying identity blendshapes, each weighted by its coefficient in an identity vector representing a specific individual person or avatar.

An expressing generic mesh (or partial mesh) may be computed by applying expression blendshapes, each weighted by its coefficient in an expression vector representing a specific facial expression.

Expression blendshapes and identity blendshapes may both be applied, resulting in a specific expressing mesh (for example, corresponding to an avatar or an actor).

Although a morphable face mesh is typically used for facial animation (i.e., to generate animations), embodiments of the invention use a morphable face mesh “in reverse” by “fitting” it to the detected facial landmarks of an actor.

Mesh Fitting: The term mesh fitting refers to the process of using a least squares approximation (or any other appropriate linear regression method) to estimate the blendshape coefficients that will morph the landmark vertices of a morphable face mesh into the best fit with detected (3D integrated) landmarks obtained from a digital camera. The detected 3D integrated landmarks must be aligned first, using point registration techniques (e.g., K-U or other affine-generating rigid alignment algorithm), especially along non-moving landmarks, such as the tip of a nose or the corners of eyes; this is so the least squares approximation will have a likely solution (i.e., the blendshapes can “reach” the landmarks).

The number of landmarks is far fewer than the vertices of the mesh (468 vs ˜30,000), so embodiments of the present invention only solve (or “fit”) the mesh using subsets of the mesh and blendshapes corresponding to the landmark vertices.

A mesh may be fitted piecewise, that is, by estimating some coefficients while holding others constant, for example, by holding the expression coefficients constant while solving for the identity coefficients, or vice versa, or by holding some expression coefficients constant while solving for other expression coefficients.

### DESCRIPTION OF THE EMBODIMENTS

Embodiments of the present invention will be described with reference to the accompanying drawings, wherein like parts are designated by like reference numerals throughout, and wherein the leftmost digit of each reference number refers to the drawing number of the figure in which the referenced part first appears.

### Overview of Expression Extraction and Transfer

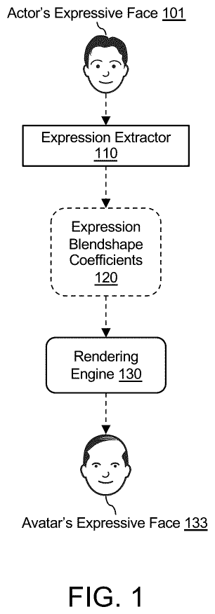

FIG. 1 provides a simplistic overview illustration of an exemplary embodiment of the invention that extracts expressions from an actor's face and transfers mathematical representations of those expressions in real time to a rendering engine that can then render the mathematical representations of the expressions onto a digital avatar's face. In accordance with embodiments of the present invention, at least two digital cameras (not shown in FIG. 1) may capture digital images of an actor's expressive face 101. Those digital images may then be provided to an expression extractor module 110. The expression extractor module 110 may then identify facial landmarks in the actor's expressive face 101 and generate a set of expression blendshape coefficients 120 (i.e., an expression vector as defined and explained above) corresponding to expressions in the actor's expressive face 101 associated with those facial landmarks. The expression blendshape coefficients 120 (the expression vector) may then be provided to a rendering engine 130, where the expressions can be rendered onto a corresponding avatar's expressive face 133. The process or method shown in FIG. 1 may repeat over and over in real time corresponding to video frame rates familiar to those skilled in the art, such as 10 to 30 frames per second (or faster). Thus, FIG. 1 illustrates, at a high level, how embodiments of the present invention can extract expressions from an actor's face and transfer them to an avatar's face in real time by converting the expressions into mathematical representations, and then using those mathematical representations (the expression vector) to render the expressions onto the avatar's face and not by transferring any portion of a graphical image or mesh of the actor's face to the rendering engine.

### Overview of Embodiments

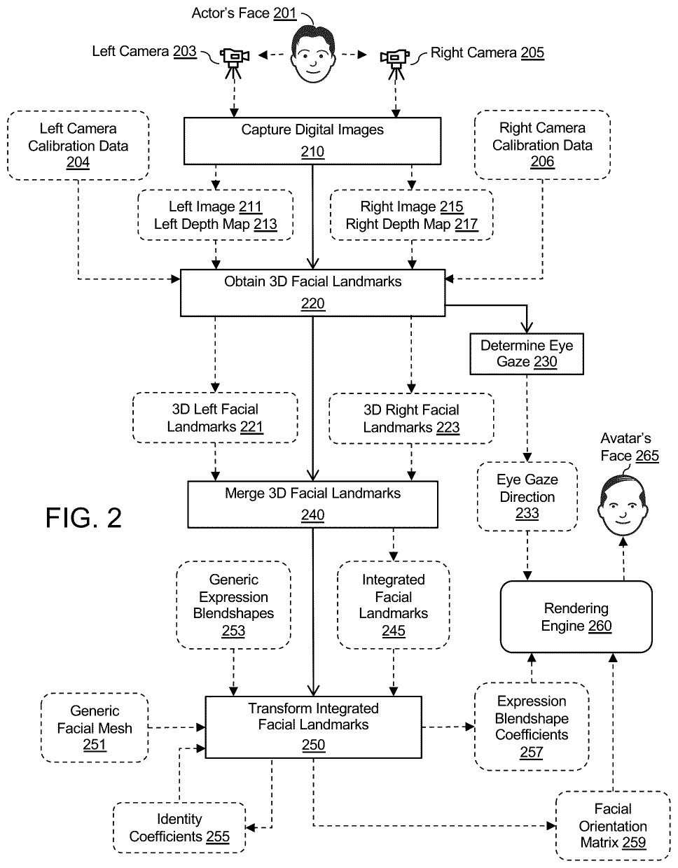

FIG. 2 illustrates an exemplary embodiment of a method and system for extracting mathematical representations of facial expressions from an actor's face in real time and transmitting coefficients of those mathematical representations to a rendering engine that can render the extracted representations of the actor's facial expressions onto an avatar's face. The method illustrated by FIG. 2 comprises the following steps: (1) capturing digital images of an actor's face 201 at step 210; (2) obtaining sets of three-dimensional (“3D”) landmarks 221 and 223 of the actor's face 201 at step 220; (3) determining the direction of eye gaze 233 in the actor's face 201 at step 230; (4) merging the sets of 3D facial landmarks 221 and 223 into a single set of integrated 3D facial landmarks 245 at step 240; (5) transforming the set of integrated 3D facial landmarks 245 into a mathematical vector of expression blendshape coefficients 257 and a facial orientation matrix 259 at step 250; and outputting to a rendering engine 260 the vector of expression blendshape coefficients 257, the facial orientation matrix 259, and the direction of eye gaze 233, thus enabling the rendering engine 260 to render the avatar's face 265 utilizing mathematical representations of the facial expressions of the actor's face 201 in real time.

The set of integrated 3D facial landmarks 245 generated at step 240 may be aligned with a generic facial mesh 251 at step 250 to produce a set of identity coefficients 255 of the actor's face 201, which can then be used in further iterations of step 250 to improve the efficiency of the facial landmark transformation process. In fact, once the set of identity coefficients 255 have been calculated several times, they can be averaged and reused (i.e., not calculated again), since they will not likely change for a given actor.

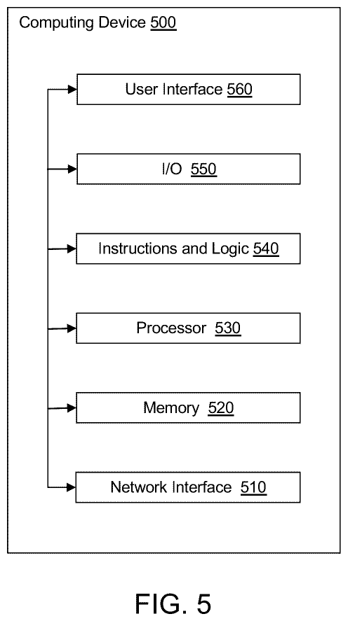

Each of the steps 210, 220, 230, 240, 250, and 260 may be performed by, or at the direction of, a computing system further described in FIG. 5.

### Capturing Digital Images of the Actor's Face

At step 210, an actor may be positioned within the view of a plurality of depth-sensing digital cameras—for example left camera 203 and right camera 205—so that a digital image (211 and/or 215) of the actor's face 201 and a depth map (213 and/or 217) of the actor's face 201 may be captured by each of the depth-sensing digital cameras 203 and/or 205. Ideally, left camera 203 and right camera 205 will be positioned sufficiently far apart so as to provide at least slightly different perspective views of the actor's face 201.

As shown in FIG. 2, left camera 203 may capture left image 211 and left depth map 213, while right camera 205 may capture right image 215 and right depth map 217. These digital images (211 and 215) and depth maps (213 and 217) may be captured repeatedly at a real time frame rate such as between 10 and 30 frames per second (or faster) and may be stored in a memory connected to a computing device (further described in FIG. 5) or they may be transmitted by means known by those skilled in the art to a downstream processing module configured to handle the next processing step, such as step 220.

Examples of left camera 203 and/or right camera 205 include: the Intel d400 series camera; the Basler Blaze Time-of-Flight (“ToF”) camera (e.g., Blaze-101); the roboception rc_visard+rc_viscore camera (e.g., rc_visard 160); the Orbbec Astra or Gemini cameras (e.g., Astra 2 or Gemini 335); and the LIPSedge AE or L series cameras (e.g., AE400 or L215u). As one of skill in the art would understand, the specific depth-sensing technology used within digital cameras 203 and/or 205 could be any depth-sensing technology and could include Time-of-Flight, Structured Light, stereo, and LiDAR.

### Obtaining 3D Facial Landmarks of the Actor's Face

Still referring to FIG. 2, at step 220 a processing module may receive a plurality of digital images and depth maps associated with the actor's face 201. For example, the processing module performing step 220 may receive left image 211, left depth map 213, right image 215, and right depth map 217. The processing module performing step 220 may then perform operations to obtain from left image 211 and left depth map 213 a set of single perspective 3D left facial landmarks 221 associated with the image of the actor's face 201 captured by left camera 203.

To obtain the set of single perspective 3D left facial landmarks 221, the processing module performing step 220 may first identify, from the left image 211, a set of single-perspective 2-dimensional facial landmarks on the actor's face 201. The 2-dimensional facial landmarks may be found by using a machine-learning model trained to detect faces. Such machine-learning models are known in the art. For example, an off-the-shelf object detection model called “You Only Look Once” (“YOLO”) may be used after it has been trained with a sufficient number of public face datasets and optionally trained with additional custom or synthetically generated face datasets.

After the set of single-perspective 2-dimensional facial landmarks on the actor's face are identified in the left image 211, the processing module associated with step 220 may convert the set of single-perspective 2-dimensional facial landmarks and the left depth map 213 into a set of single-perspective 3-dimensional 3D left facial landmarks 221. The conversion from 2D to 3D is a mathematical operation known in the art as a deprojection, which requires using known intrinsic properties of a digital camera (here, left camera 203) and the values produced by its depth channel (left depth map 213) to convert the 2-dimensional coordinates generated by the camera (stored in the set of single-perspective 2-dimensional facial landmarks) into 3-dimensional coordinates produced by the processing module performing step 220 as the set of single-perspective 3-dimensional 3D left facial landmarks 221.

Similarly for the right side of the actor's face 201, the processing module performing step 220 may perform operations to obtain from right image 215 and right depth map 217 a set of single perspective 3D right facial landmarks 223 associated with the image of the actor's face 201 captured by right camera 205. The same operations described above to create the set of single perspective 3D left facial landmarks 221 may be performed to create the set of single perspective 3D right facial landmarks 223 from right image 215 and right depth map 217.

As will be appreciated by one of skill in the art, any number of cameras may be used to obtain 3D facial landmark data, and the invention described herein is not limited to two cameras.

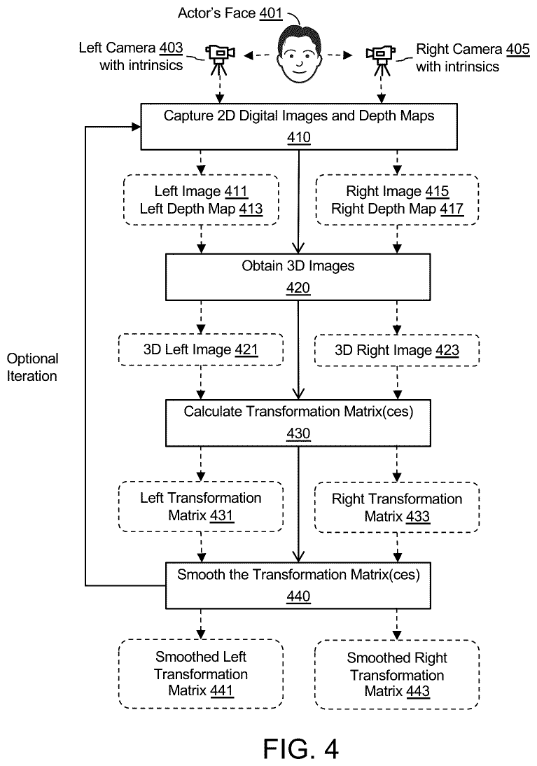

Following a calibration process illustrated in FIG. 4 (described below), the processing module performing step 220 may use left camera calibration data 204 to further refine the positions of each coordinate in the single perspective 3D left facial landmarks 221 and optionally to select the left camera 203 coordinate system as the reference camera coordinate system described in the definition section above. Similarly, the processing module performing step 220 may use right camera calibration data 205 to further refine the positions of each coordinate in the single perspective 3D right facial landmarks 223 and optionally to convert the single perspective 3D right facial landmarks 223 into the coordinate system of the reference camera.

### Determining Eye Gaze Direction

Still with respect to FIG. 2, when a 2-dimensional digital image (211 or 215) has been captured of the actor's face 201, the direction of eye gaze in the actor's face 201 may be calculated at step 230 by a processing module. The processing module may begin step 230 by identifying at least one pupil location in at least one of the 2D digital images 211 or 215, or alternatively by first using either of the sets of 3D facial landmarks (221 or 223) to locate the eye region, and then using standard computer vision methods to detect the pupil. Roughly, these methods may be summarized by the phrase “finding a black oval shape mostly surrounded by white” and may be accomplished by standard computer vision algorithms.

Once the pupil has been located in at least one of the 2D digital images (211 or 215) or in at least one of the sets of 3D facial landmarks (221 or 223), the direction of eye gaze 233 in the actor's face 201 may be calculated as a vector from a centroid of an eyeball mesh to the location of the pupil, and then the eye gaze direction vector 233 may be output to a rendering engine 260.

### Merging the 3D Facial Landmarks of the Actor's Face

Staying with FIG. 2, a processing module performing step 240 may receive the set of single-perspective 3-dimensional 3D left facial landmarks 221 and the set of single-perspective 3-dimensional 3D right facial landmarks 223 generated at step 220 and then merge the two sets of single-perspective facial landmarks (221 and 223) to produce a set of 3D integrated facial landmarks 245 of the actor's face 201.

The merging operation at step 240 may include identifying non-visible facial landmarks in each of the sets of single-perspective 3-dimensional facial landmarks 221 and/or 223. Non-visible facial landmarks may be identified by a number of methods. For example, a facial landmark may be identified as non-visible because it was not captured in one of the sets of single-perspective 3-dimensional facial landmarks. A facial landmark may also be identified as non-visible based on the use of ray tracing algorithms that determine which facial landmarks are visible from the perspective of a corresponding digital camera (203 or 205).

As another example of identifying a non-visible facial landmark, a facial landmark may be identified as non-visible because it may be located outside a pre-defined boundary around the actor's face 201 and may therefore be considered an algorithmic mistake or an artifact that can or should be ignored.

The merging operation at step 240 may assemble the set of integrated 3-dimensional facial landmarks 245 by calculating an integrated location of each visible facial landmark on the actor's face 201 based on the location of each visible facial landmark found in each of the sets of single-perspective 3-dimensional facial landmarks (221 and 223). The integrated location of each visible facial landmark on the actor's face 201 may be calculated by determining the centroid or average location of each corresponding visible facial landmark found in each set of single-perspective 3-dimensional facial landmarks (221 and/or 223). The integrated location of each visible facial landmark on the actor's face 201 may also be calculated by selecting from one of the sets of single-perspective 3-dimensional facial landmarks (either 221 or 223), the facial landmark that most directly faces its corresponding depth-sensing digital camera, essentially giving priority to the digital camera that is either closest to the facial landmark or the digital camera that has a better view of the facial landmark in question.

### Transforming the Integrated Facial Landmarks—Overview

At step 250 of FIG. 2, a processing module may receive as inputs (1) the set of integrated 3-dimensional facial landmarks 245 generated by step 240; (2) a generic facial mesh 251; (3) a set of generic expression blendshapes 253; and (4) optionally, after several iterations of step 250, a set of identity coefficients 255 of the actor's face 201. The processing module performing step 250 may then transform the set of integrated 3-dimensional facial landmarks 245 into a vector of expression blendshape coefficients 257 and a facial orientation matrix 259, both of which may then be output to rendering engine 260.

Using the vector of expression blendshape coefficients 257, the facial orientation matrix 259, and eye gaze direction vector 233, the rendering engine 260 may render an avatar's face 265 in a manner that conveys on the avatar's face 265 substantially the same facial expression that appeared on the actor's face 201 and which was captured and converted to expression blendshape coefficients 257 by the sequence of processing modules executing steps 210, 220, 240, and 250.

Facial orientation matrix 259 may be derived from integrated facial landmarks 245 according to methods known in the art. It may be expressed as either a vector or a matrix of affine transformation values describing a spatial position and orientation of the actor's face 201.

Each expression blendshape coefficient in the vector of expression blendshape coefficients 257 will correspond to an expression blendshape found in the set of generic expression blendshapes 253.

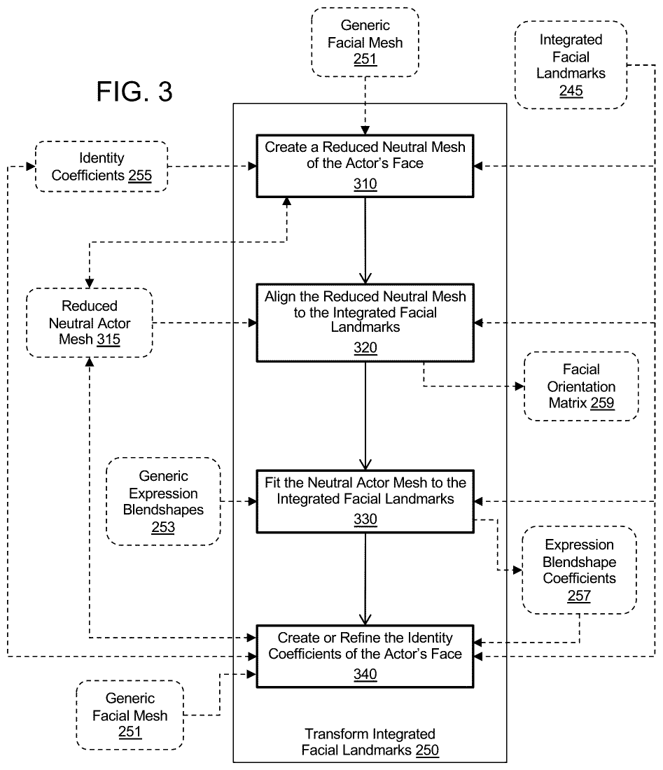

In summary, the processing module at step 250 may transform the set of integrated 3-dimensional facial landmarks 245 into a vector of expression blendshape coefficients 257 by performing a series of steps that are explained in more detail in FIG. 3. In general, however, the processing module at step 250 may first create a neutral mesh of the actor's face based on the generic facial mesh 251 and identity coefficients 255 (if they are available from previous iterations; if they are not available, the generic facial mesh 251 is used). Then, the processing module at step 250 will align the neutral mesh of the actor's face with the integrated facial landmarks 245. Then, the processing module at step 250 will iteratively execute a regression algorithm to obtain expression blendshape coefficients 257 that minimize the distances between the vertices of the integrated 3-dimensional facial landmarks 245 and the corresponding landmark vertices in the neutral mesh of the actor's face. The resulting expression blendshape coefficients 257 will enable rendering engine 260 to apply the expression blendshape coefficients 257 to corresponding blendshapes in the avatar's face 265 which will cause the avatar's face 265 to portray the same expressions that were present on the actors face 201.

### Transforming the Integrated Facial Landmarks—More Detail

FIG. 3 is a more detailed illustration of an exemplary embodiment of a method and system for transforming integrated 3-dimensional facial landmarks of an actor's face into coefficients of expression blendshapes that can be used by a rendering engine to render expressions obtained from an actor's face onto an avatar's face. More specifically, FIG. 3 is a more detailed illustration of the processing module at step 250 of FIG. 2, which transforms the set of integrated 3-dimensional facial landmarks 245 (shown in FIG. 2) into a vector of expression blendshape coefficients 257 (shown in FIG. 2).

The method shown in FIG. 3 begins at optional step 310, where a reduced neutral mesh of an actor's face 315 is created, which will be fitted to match the integrated 3-dimensional facial landmarks 245 using expression blendshapes. If identity coefficients 255 are available from a previous pass of the method shown in FIG. 3 (see below), then the identity coefficients 255 are applied to the generic facial mesh 251, producing a reduced neutral mesh of the actor's face 315. Otherwise, the generic facial mesh 251 is selected as the starting point for the reduced neutral mesh of the actor's face 315.

Once the neutral mesh of an actor's face 315 is created, step 310 may be optionally skipped. Alternatively, step 310 may be executed periodically to refine the accuracy of the neutral mesh of an actor's face 315.

Not all the mesh and blendshape vertices of the generic facial mesh 251 are used to create the reduced neutral actor mesh 315. Instead, only those mesh and blendshape vertices corresponding to the integrated 3-dimensional facial landmarks 245 are used. This is because the integrated 3-dimensional facial landmarks 245 are the only vertices available to fit against. Also, processing a subset of the vertices makes this process much faster than it otherwise would be.

Next, at step 320 of FIG. 3, embodiments of the invention may align the reduced neutral actor mesh 315 to the integrated 3-dimensional facial landmarks 245. Intuitively, this alignment step can be thought of as “lining up” the mesh 315 with the landmarks 245, in preparation for blendshapes to distort the morphable face mesh (315) in order to closely “fit” them.

Not all of the landmark 245 vertices are used in computing this alignment. Only the least-volatile face landmarks (e.g., tip of the nose, center forehead, corners of the eyes) are used. Intuitively, this is because the landmarks 245 are “expressing” (e.g., smiling), but the reduced neutral actor mesh 315 is neutral, so to maximize both the efficiency and accuracy of the alignment step 320, embodiments of the invention will align the parts of the face that do not move as much, so the most appropriate (i.e., expressive) blendshapes will be able to “reach” the more volatile or expressive landmarks in the set of integrated 3-dimensional facial landmarks 245.

The alignment in step 320 is achieved by computing an affine geometric transformation using, for example, the Kabsch-Umeyama Point Registration Algorithm.

Following the alignment operation, the facial orientation matrix 259 can be generated, since the alignment will automatically encode the orientation and positioning of the actor's head in space.

It is important to note the direction of transformation in the alignment step. During alignment, the reduced neutral actor mesh 315 is transformed from an arbitrary model space into “real” space (not vice versa). Although the fitting algorithm would work in either coordinate system, this specific transform direction is chosen to enable the creation of the facial orientation matrix 259.

At step 330 of FIG. 3, embodiments of the invention may expression-fit the aligned reduced neutral actor mesh 315 to the integrated 3-dimensional facial landmarks 245 in order to create a set of expression blendshape coefficients 257. In this step, a least squares approximation method is applied to (linear) generic expression blendshapes 253 to obtain multipliers (coefficients) that will minimize the distances between the landmark vertices in the reduced neutral actor mesh 315 and their corresponding landmarks in the set of integrated 3-dimensional facial landmarks 245.

It is important to note that identity blendshape coefficients 255 (if they were available at step 310) were pre-applied to the reduced neutral actor mesh 315, while generic expression blendshapes 253 were not; thus, only expression coefficients (the expression blendshape coefficients 257) are created in step 330, with reference to the neutral (i.e., expressionless) actor mesh 315.

Now, at step 340 of FIG. 3, embodiments of the invention may create or refine the identity coefficients 255 of the actor's face. To accomplish this goal, a new neutral actor mesh 315 will be created, which will then be fitted to match the integrated 3-dimensional facial landmarks 245 using identity blendshapes.

First, the expression blendshape coefficients 257, which were computed above, will be applied to the generic facial mesh 251, thus producing an initial version of the new neutral actor mesh 315. As with the expression fitting steps above, only landmark vertices (i.e., a “reduced” mesh) are used. The previously computed affine transform is used to align the new neutral actor mesh 315 with the integrated 3-dimensional facial landmarks 245 using the same affine geometric transform as above.

Then, the new neutral actor mesh 315 is identity-fitted to the integrated 3-dimensional facial landmarks 245. A least squares approximation method is applied to (linear) identity blendshapes (not shown) to obtain identity coefficients 255 that minimize the distance between landmark vertices (in the new neutral actor mesh 315) and corresponding landmarks (in the integrated 3-dimensional facial landmarks 245).

The identity coefficients 255 should be kept in memory or storage and possibly temporally averaged with past values, for later use in expression fitting (such as in steps 320 and 330), either immediately or for the next frame.

It is important to understand that expression blendshapes were pre-applied to the reduced neutral actor mesh 315, while identity blendshapes were not; thus, only identity coefficients are estimated in step 340, with reference to an expressing generic (average) mesh.

Optionally, the steps in FIG. 3 can be repeated on the same video frame, using the newly computed identity coefficients 255 vector to obtain a better mesh alignment and refined solutions to expression and identity. Such a decision (to repeat the steps in FIG. 3) may rely on overall residuals (errors) after fitting or be based on a fixed or maximum number of iterations.

Optionally, the identity coefficients 255 vector can be temporally averaged to further stabilize it.

Optionally, once the identity coefficients 255 vector has sufficiently stabilized, it can be stored for permanent reference. Subsequently, the identity fitting steps can be skipped and the stored values used in expression fitting, thus saving processing time.

The identity coefficients 255 vector should stabilize over time because it encodes the persistent shape and features of the actor's head and face, in contrast to the expression blendshape coefficients 257 vector, which encodes an ephemeral expression of the actor from moment to moment.

The identity coefficients 255 vector will be unique to the individual actor and therefore it can be used in a later instantiation of embodiments.

### Calibration

FIG. 4 illustrates an exemplary embodiment of a method for calibrating depth-sensing digital cameras for generating digital avatars, in accordance with the present invention.

The depth-sensing digital cameras 403 and/or 405 (which are the same as cameras 203 and 205 shown in FIG. 2) may be calibrated and their coordinate systems synchronized and translated to a common coordinate system so as to enable the methods illustrated in FIGS. 2 and 3 to use multiple cameras effectively. The calibration process of FIG. 4 may include the step of capturing 2-dimensional digital images 410 of a digital image of the actor's face 401 from each of the depth-sensing digital cameras 403 and/or 405. Ideally, left camera 403 and right camera 405 will be positioned sufficiently far apart so as to provide at least slightly different perspective views of the actor's face 401. The calibration process illustrated in FIG. 4 may be performed offline, prior to the real-time process of extracting actor expressions and rendering them onto an avatar. Alternatively, the calibration process illustrated in FIG. 4 may be performed in parallel with the real-time process of extracting actor expressions and rendering them onto an avatar.

As shown in FIG. 4, left camera 403 may capture left image 411 and left depth map 413, while right camera 405 may capture right image 415 and right depth map 417. These digital images (411 and 415) and depth maps (413 and 417) may be captured and stored in a memory connected to a computing device (further described in FIG. 5) or be transmitted by means known by those skilled in the art to a processing module configured to perform the step of obtaining 3D images from the digital images and depth maps 420. More specifically, step 420 may obtain 3D left image 421 by combining information from 2-dimensional left image 411 and left depth map 413. Similarly, step 420 may obtain 3D right image 423 by combining information from 2-dimensional right image 415 and right depth map 417.

At step 430, a processing module may then calculating transformation matrices 431 and 433 corresponding to each of the 3D digital images (421 and 423) by calculating an affine transformation calibration matrix associated with each depth-sensing digital camera to map subsequently captured images from depth-sensing digital cameras 403 and/or 405 into a common or reference coordinate space.

To create the transformation matrices, the processing module at step 430 may calculate an affine left transformation matrix 431 to map the left 3D image 421 into the coordinate space of right camera 405. Alternatively, the processing module at step 430 may calculate an affine right transformation matrix 433 to map the right 3D image 423 into the coordinate space of left camera 405. Step 430 may take into account the camera intrinsic values associated with each camera 403 and/or 405. The Kabsch-Umeyama algorithm may be used to compute scale, rotation, and translation components of each transformation calibration matrix.

The processing module at step 440 may additionally apply a temporal smoothing calculation to each of the affine transformation matrices 431 and 433 to create a smoothed left transformation matrix 441 and a smoothed right transformation matrix 443, respectively.

The calibration process may be repeated iteratively from step 410 to step 440.

Referring now to FIG. 2, the smoothed left transformation matrix 441 from FIG. 4 may be used as left camera calibration data 204 (meaning they correspond to each other). Similarly, the smoothed right transformation matrix 443 from FIG. 4 may be used as right camera calibration data 206.

### Computing Device

FIG. 5 is a block diagram of an exemplary embodiment of a Computing Device 500 in accordance with the present invention, which in certain operative embodiments can comprise, for example, processing modules that perform the operations described in steps described with reference to FIGS. 1 through 4. Computing Device 500 may comprise any of numerous components, such as for example, one or more Network Interfaces 510, one or more Memories 520, one or more Processors 530, program Instructions and Logic 540, one or more Input/Output (“I/O”) Devices 550, and one or more User Interfaces 560 that may be coupled to the I/O Device(s) 550, etc.

Computing Device 500 may comprise any device known in the art that is capable of processing data and/or information, such as any general purpose and/or special purpose computer, including as a personal computer, workstation, server, minicomputer, mainframe, supercomputer, computer terminal, laptop, tablet computer (such as an iPad), wearable computer, mobile terminal, Bluetooth device, communicator, smart phone (such as an iPhone, Android device, or BlackBerry), a programmed microprocessor or microcontroller and/or peripheral integrated circuit elements, a high speed graphics processing unit, an ASIC or other integrated circuit, a hardware electronic logic circuit such as a discrete element circuit, and/or a programmable logic device such as a PLD, PLA, FPGA, or PAL, or the like, etc. In general, any device on which a finite state machine resides that is capable of implementing at least a portion of the methods, structures, API, and/or interfaces described herein may comprise Computing Device 500.

Memory 520 can be any type of apparatus known in the art that is capable of storing analog or digital information, such as instructions and/or data. Examples include a non-volatile memory, volatile memory, Random Access Memory, RAM, Read Only Memory, ROM, flash memory, magnetic media, hard disk, solid state drive, floppy disk, magnetic tape, optical media, optical disk, compact disk, CD, digital versatile disk, DVD, and/or RAID array, etc. The memory device can be coupled to a processor and/or can store instructions adapted to be executed by processor, such as according to an embodiment disclosed herein. In certain embodiments, Memory 520 may be augmented with an additional memory module, such as the HiTech Global Hybrid Memory Cube.

Input/Output (I/O) Device 550 may comprise any sensory-oriented input and/or output device known in the art, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, vibrator, tactile simulator, and/or tactile pad, optionally including a communications port for communication with other components in Computing Device 500.

Instructions and Logic 540 may comprise directions adapted to cause a machine, such as Computing Device 500, to perform one or more particular activities, operations, or functions. The directions, which can sometimes comprise an entity called a “kernel”, “operating system”, “program”, “application”, “utility”, “subroutine”, “script”, “macro”, “file”, “project”, “module”, “library”, “class”, “object”, or “Application Programming Interface,” etc., can be embodied as machine code, source code, object code, compiled code, assembled code, interpretable code, and/or executable code, etc., in hardware, firmware, and/or software. Instructions and Logic 540 may reside in Processor 530 and/or Memory 520.

Network Interface 510 may comprise any device, system, or subsystem capable of coupling an information device to a network. For example, Network Interface 510 can comprise a telephone, cellular phone, cellular modem, telephone data modem, fax modem, wireless transceiver, Ethernet circuit, cable modem, digital subscriber line interface, bridge, hub, router, or other similar device.

Processor 530 may comprise a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. Processor 530 can function as a central processing unit, local controller, remote controller, parallel controller, and/or distributed controller, etc.

Processor 530 can comprise a general-purpose computing device, including a microcontroller and/or a microprocessor. In certain embodiments, the processor can be dedicated purpose device, such as an Application Specific Integrated Circuit (ASIC), a high-speed Graphics Processing Unit (GPU) or a Field Programmable Gate Array (FPGA) that has been designed to implement in its hardware and/or firmware at least a part of an embodiment disclosed herein. In certain embodiments, Processor 530 can be a Tegra X1 processor from NVIDIA or Raspberry PI or NVIDIA Jetson board. In other embodiments, Processor 530 can be a Jetson TXI processor from NVIDIA, optionally operating with a ConnectTech Astro Carrier and Breakout board, or competing consumer product (such as a Rudi (PN ESG503) or Rosic (PN ESG501) or similar device). In another embodiment, the SFF device 750 is the Xilinx proFPGA Zync 7000 XC7Z100 FPGA Module. In yet another embodiment, Processor 530 can be a HiTech Global Kintex Ultrascale-115. In still another embodiment, Processor 530 can be a standard PC that may or may not include a GPU.

User Interface 560 may comprise any device and/or means for rendering information to a user and/or requesting information from the user. User Interface 560 may include, for example, at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, auto-sizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.

The present invention can be realized in hardware, software, or a combination of hardware and software. The invention can be realized in a centralized fashion in one computer system, or in a distributed fashion where different elements are spread across several computer systems. Any kind of computer system or other apparatus adapted for carrying out the methods described herein is suitable. A typical combination of hardware and software can be a general-purpose computer system with a computer program that, when being loaded and executed, controls the computer system such that it carries out the methods described herein.

### Key Features and Benefits

Embodiments of the invention enable a video conferencing tool to be extended, so that instead of an actor's face appearing in a user's video-conferencing application, an avatar's face may appear instead. During the video conference, a user can interact with the actor but not perceive the actor's actual identity, as the user only sees (and hears) the avatar's face (and voice).

Full Face: Embodiments of the invention can allow an actor's full face to be represented by an avatar, because the embodiments allow for multiple cameras in different locations (nominally two cameras, positioned to the left and right of the actor). This provides for a realistic and accurate representation of the actor's avatar, especially as compared to other systems known in the art, which may use only one camera or no depth information, or as compared to systems that attempt to mimic the user's expressions based only on audio cues.

Face and Body: Embodiments of the invention can allow an actor's face, head, and upper torso to be represented by an avatar, because embodiments allow for multiple cameras in different locations. In addition, embodiments of the invention could be implemented alongside a standard motion-capture system, allowing expressions of an actor to be transferred to a full-body model of the avatar, while the avatar body is also being driven by the actor's body.

Real Time: Embodiments of the invention permit an avatar to faithfully mimic an actor's facial expressions and body movements in real-time.

Audio: Embodiments of the invention permit an actor's voice to be presented as an audio signal in sync with a corresponding display of the avatar. The actor's voice may be transformed to match the appearance of the avatar. The audio signal may be timestamped so that it can be delivered in sync with the avatar video.

No Cloud: Embodiments of the invention may be configured to perform only local on-board processing, in order to maintain low-latency delivery of the actor's facial expressions to the avatar. In particular, embodiments of the invention do not require any cloud-based communication or resources which might present privacy or security concerns.

Cameras: Embodiments of the invention may use one or more cameras providing both depth and RGB data at a rate of between 10 and 30 frames per second, or faster. The depth sensor capability of the cameras may be implemented using structured light, LIDAR, or other means, provided the depth sensing technology has a resolution of better than roughly one millimeter at a distance of roughly one meter. The RGB sensor should have a resolution of better than roughly one megapixel. The cameras may use USB-3 connections to assure high bandwidth and low latency. By using multiple cameras, a more faithful and accurate avatar representation is possible, especially as compared to other systems in the art, which capture only gross or coarse data and impute movement through prediction or simulation.

Microphones: Embodiments of the invention may use one or more commercial, USB, mono or stereo microphones.

GPU: Embodiments of the invention may use dual, high-end GPUs.

No Actor Training: Embodiments of the invention do not require an actor to undergo any specific training, for example, to move only in certain ways or to avoid certain types of facial expressions.

No PII: Embodiments of the invention may not collect or maintain any PII (Personally Identifiable Information) about the actor. While some information about the actor's neutral face and motion is captured, this data is only stored locally. Furthermore, actor data is only expressed as numerical coefficients of mathematical structures used within the context of the system; that is, the data in isolation is not likely to be useful to a third-party.

Any Actor: Embodiments of the invention may be used by any actor, regardless of age, gender, facial shape, hair style, etc., because the embodiments are computing the actor's current expression relative to the actor's neutral expression, as opposed to detecting certain a priori facial shapes or expressions. Embodiments do not require any actor preparation (e.g., dots on face or head-mounted gear).

Any Avatar: An avatar of any age, gender, facial shape, hair style, etc., can be used to represent the actor, because the embodiments operate by morphing the avatar from a neutral expression to the actor's expression. No knowledge of a specific actor is required.

Actor/Avatar Independence: Embodiments of the invention transfer an actor's facial expression to the fact of an avatar that has been created independently from any attributes of the eventual actor(s) who will drive the avatar. This allows the embodiments to run with any actor matched to any avatar. In particular, this means an avatar can be designed to look like anyone; it is not constrained to try and replicate the look of the actor.

3D Model: The avatar may be rendered as a standard 3D object. This means it can be placed in any custom 3D environment, viewed from any angle, subjected to any custom lighting scheme, augmented by custom background noise, etc.

Avatar Customization: The avatar may be built using industry-standard graphics tools, which simplifies the avatar creation process and also allows the avatar to be easily “placed” inside any standard 3D environment or video conferencing system.

Special Effects: Embodiments of the invention can artificially add audio or video effects as part of the avatar rendering process, such as a stutter, compression artifacts, lag, background noise, etc. These effects can be used to mask any deficiencies in the facial expression extraction or rendering process in such a way that a typical user would perceive the effects as “normal” problems experienced with any video conferencing tool.

Actor Hardware: Embodiments of the invention may operate in real-time with high facial fidelity, where any actor can drive any avatar, in such a way that the actor does not require special training, awkward headgear, VR-style goggles, or the placement of motion-capture dots. Embodiments' use of multiple cameras with depth sensors may be used to capture the user's facial expressions and body movements with great accuracy. This also allows the user to act naturally and without artificial constraints.

2D Applicability: Embodiments of the invention inherently generate 3D imagery, from the depth-sensing cameras to the 3D output from the rendering engine. However, the output from the renderer can be projected to a 2D view for use in conventional video conferencing systems.

Multiple Systems: Without loss of generality, embodiments of the invention can be used to portray multiple avatars, corresponding to multiple actors in the target virtual environment. In the simplest case, a two-party video conference can be held with two actors being represented independently by different avatars; in the general case, a virtual world could be populated by many actors, each controlling one (or more) avatars.

UI: Embodiments of the invention may employ a user interface that can be manipulated by an actor to control the entire workflow of image capture and rendering.

Realism. Embodiments of the invention are improvements over known methods such as snapchat filters, face-swapping and similar technologies. Embodiments of the present invention drive a high-fidelity rendering system, with the goal of achieving realism or at least believability, as opposed to the chat filter goal of amusement or anonymity with a cartoony mask.

### Variations

Multiple Cameras: Embodiments of the invention typically use two RGB+depth digital cameras. More cameras may be added, possibly with different sensors, to increase the realism of the system. For example, an additional camera might be focused only on the mouth or on the eyes.

Guard Rails: The facial expression extraction component of embodiments can provide feedback to the actor. For example, the facial expression extractor may detect that the actor's face has gone out of the cameras' frames, or that insufficient landmarks are being detected to generate a realistic avatar.

Custom Hardware: Embodiments of the invention may use custom hardware, such as ASICs or FPGAs, which implement one or more of the facial expression extraction algorithms, in order to improve performance or decrease cost.

Camera Boards: Embodiments of the invention may have one or more of the cameras attached to a separate computer, such as a Raspberry PI or NVIDIA Jetson board, which may then be attached to a workstation via ethernet. This architecture would allow for some of the initial stages in the feature extraction process (such as face detection and landmark detection) to be offloaded to the camera board, in order to improve overall performance.

Encryption: In order to maintain a secure and private system, the various communication channels between components of the embodiments could be encrypted. Any locally stored data, such as an actor's profile, could be stored in an encrypted state.

Producer Role: An actor may be paired with a producer who can monitor the state of the interaction between the actor/avatar and the end user, so as to be able to manually intervene as needed—for example, to be able to inject background noise or visual effects to cover observed rendering errors.

### CONCLUSION

Although the present disclosure provides certain embodiments and applications, other embodiments apparent to those of ordinary skill in the art, including embodiments that do not provide all of the features and advantages set forth herein, are also within the scope of this disclosure.

The present invention, as already noted, can be embedded in a computer program product, such as a computer-readable storage medium or device which when loaded into a computer system is able to carry out the different methods described herein. “Computer program” in the present context means any expression, in any language, code or notation, of a set of instructions intended to cause a system having an information processing capability to perform a particular function either directly or indirectly after either or both of the following: a) conversion to another language, code or notation; or b) reproduction in a different material form.

The foregoing disclosure has been set forth merely to illustrate the invention and is not intended to be limiting. It will be appreciated that modifications, variations, and additional embodiments are covered by the above teachings and within the purview of the appended claims without departing from the spirit and intended scope of the invention. Other logic may also be provided as part of the exemplary embodiments but are not included here so as not to obfuscate the present invention. Since modifications of the disclosed embodiments incorporating the spirit and substance of the invention may occur to persons skilled in the art, the invention should be construed to include everything within the scope of the appended claims and equivalents thereof.

The invention claimed is:

1. A computerized method for transferring a facial expression of an actor to an avatar-generating rendering engine, comprising the following steps:
capturing, from each of a plurality of depth-sensing digital cameras, a 2D digital image of an actor's face and a corresponding depth map of the actor's face;
obtaining, from each 2D digital image and corresponding depth map, a set of single-perspective 3-dimensional facial landmarks on an actor's face;
merging the sets of single-perspective 3-dimensional facial landmarks into a set of integrated 3-dimensional facial landmarks on the actor's face;
transforming the set of integrated 3-dimensional facial landmarks into (a) a vector of expression blendshape coefficients, where each of the expression blendshape coefficients corresponds to one of a plurality of expression blendshapes, and where each such expression blendshape is associated with a different facial expression, and (b) a facial orientation matrix of affine transformation values describing a spatial position and orientation of the actor's face;
determining a direction of eye gaze in the actor face;
outputting to a rendering engine the vector of expression blendshape coefficients, the facial orientation matrix, and the direction of eye gaze.

2. The method of claim 1, wherein the determining a direction of eye gaze in the actor's face comprises:
identifying a pupil position in at least one of the 2D digital images;
converting the pupil position to a 3-dimensional pupil position; and
calculating the direction of eye gaze in the actor's face as a vector formed by a centroid of an eyeball mesh and the 3-dimensional pupil position.

3. The method of claim 1, wherein the obtaining step comprises for each depth-sensing digital camera:
identifying, in the digital image of the actor's face, a set of single-perspective 2-dimensional facial landmarks on the actor's face; and
converting the set of single-perspective 2-dimensional facial landmarks and the corresponding depth map into the set of single-perspective 3-dimensional facial landmarks.

4. The method of claim 3, wherein the single-perspective 2-dimensional facial landmarks are found by a machine-learning model trained to detect faces.

5. The method of claim 1, wherein the merging step comprises:
identifying non-visible facial landmarks in each of the sets of single-perspective 3-dimensional facial landmarks;
assembling the set of integrated 3-dimensional facial landmarks by calculating the integrated location of each visible facial landmark on the actor's face based on the location of each corresponding facial landmark in each set of single-perspective 3-dimensional facial landmarks.

6. The method of claim 5, wherein each non-visible facial landmark is identified by not being visible by one of the depth-sensing digital cameras.

7. The method of claim 5, wherein each non-visible facial landmark is identified by its location being outside a bounding sphere that encompasses the actor's face.

8. The method of claim 5, wherein the integrated location of each visible facial landmark is calculated by determining the centroid of corresponding facial landmarks in the sets of single-perspective 3-dimensional facial landmarks.

9. The method of claim 5, wherein the integrated location of each visible facial landmark is calculated by selecting, from one of the sets of single-perspective 3-dimensional facial landmarks, the facial landmark that most directly faces its corresponding depth-sensing digital camera.

10. The method of claim 1, further comprising:
aligning the set of integrated 3-dimensional facial landmarks with a generic facial mesh;
finding a set of identity coefficients that minimizes a calculated difference between each of the plurality of identity blendshapes and its corresponding facial landmark in the set of integrated 3-dimensional facial landmarks;
applying the set of identity coefficients to the generic facial mesh to create a neutral mesh of the actor's face.

11. The method of claim 10, wherein the transforming step further comprises:
aligning the set of integrated 3-dimensional facial landmarks with the neutral mesh of the actor's face;
finding a set of expression coefficients that minimizes a calculated difference between each of the plurality of expression blendshapes and its corresponding facial landmark in the set of integrated 3-dimensional facial landmarks; and
converting the set of expression coefficients into the vector of expression blendshape coefficients.
